(19) United States
(12) Patent Application Publication
(10) Pub. No.: US 2023/0241557 A1
(43) Pub. Date: Aug. 3, 2023

(54) MEMBRANES AND METHOD FOR REMOVING TRACE METALS

(71) Applicant: ENTEGRIS, INC., Billerica, MA (US)

(72) Inventors: James Hamzik, North Billerica, MA (US); Ying Qi, Westford, MA (US); Justin Brewer, North Billerica, MA (US); Kusum Maharjan, Tyngsboro, MA (US); Lucas Benjamin Snyder, Lowell, MA (US)

(21) Appl. No.: 18/103,337

(22) Filed: Jan. 30, 2023

Related U.S. Application Data
(60) Provisional application No. 63/305,512, filed on Feb. 1, 2022.

(51) Int. Cl. B01D 69/02; B01D 71/36; B01D 67/00; B01D 69/12; B01D 61/02; C07B 63/00

(52) U.S. Cl. CPC B01D 69/02; B01D 71/36; B01D 67/00931; B01D 69/1214; B01D 61/025; C07B 63/00; B01D 2323/30; B01D 2323/36; B01D 2325/18

(57) ABSTRACT

The disclosure provides certain porous polymeric membranes, coated with cross-linked polymerized monomers, comprising monomers having a charge when immersed in an organic liquid. The membranes of the disclosure are useful in removing trace amounts of metallic impurities thereby providing ultra-pure organic liquids.

### TECHNICAL FIELD

The disclosure relates to membranes useful in the removal of trace metals from liquids such as solvents, in particular photoresist chemicals.

### BACKGROUND

Filter products are indispensable tools of modern industry, used to remove unwanted materials from a flow of a useful fluid. Useful fluids that are processed using filters include water, liquid industrial solvents and processing fluids, industrial gases used for manufacturing or processing (e.g., in semiconductor fabrication), and liquids that have medical or pharmaceutical uses. Unwanted materials that are removed from fluids include impurities and contaminants such as particles, microorganisms, and dissolved chemical species. Specific examples of filter applications include their use with liquid materials for semiconductor and microelectronic device manufacturing.

To perform a filtration function, a filter includes a filter membrane that is responsible for removing unwanted material from a fluid that passes through the filter membrane. The filter membrane may, as required, be in the form of a flat sheet, which may be wound (e.g., spirally), flat, pleated, or disk-shaped. The filter membrane may alternatively be in the form of a hollow fiber. The filter membrane can be contained within a housing or otherwise supported so that fluid that is being filtered enters through a filter inlet and is required to pass through the filter membrane before passing through a filter outlet.

A filter membrane can be constructed of a porous structure that has average pore sizes that can be selected based on the use of the filter, i.e., the type of filtration performed by the filter. Typical pore sizes are in the micron or sub-micron range, such as from about 0.001 micron to about 10 microns. Membranes with average pore size of from about 0.001 to about 0.05 micron are sometimes classified as ultrafilter membranes. Membranes with pore sizes between about 0.05 and 10 microns are sometimes referred to as microporous membranes.

A filter membrane having micron or sub-micron-range pore sizes can be effective to remove an unwanted material from a fluid flow either by a sieving mechanism or a non-sieving mechanism, or by both. A sieving mechanism is a mode of filtration by which a particle is removed from a flow of liquid by mechanical retention of the particle at a surface of a filter membrane, which acts to mechanically interfere with the movement of the particle and retain the particle within the filter, mechanically preventing flow of the particle through the filter. Typically, the particle can be larger than pores of the filter. A “non-sieving” filtration mechanism is a mode of filtration by which a filter membrane retains a suspended particle or dissolved material contained in flow of fluid through the filter membrane in a manner that is not exclusively mechanical, e.g., that includes an electrostatic mechanism by which a particulate or dissolved impurity is electrostatically attracted to and retained at a filter surface and removed from the fluid flow; the particle may be dissolved, or may be solid with a particle size that is smaller than pores of the filter medium.

The removal of ionic materials such as dissolved anions or cations from solutions is important in many industries, such as the microelectronics industry, where ionic contaminants and particles in very small concentrations can adversely affect the quality and performance of microprocessors and memory devices.

A need still exists for improved methodologies for removing metal contaminants from organic solvents. In particular, a need still exists for materials that enable the removal of metal contaminants used, for example, but not limited to, semiconductor processing industry, such as, for example, in photoresist applications, which require solvents having ultra-low amounts, i.e., at the part per trillion level (PPT) of ionic metal contaminants.

### SUMMARY

In summary, the disclosure provides various porous membranes, membrane assemblies, and filter devices capable of removing trace amounts of metal ions from organic liquids. In some embodiments, the organic liquids can be solvents used in semiconductor and microelectronic device manufacturing, including, but not limited to solvents used in photolithography applications. In certain embodiments, the membranes of the disclosure are comprised of poly(tetrafluoroethylene), wherein the membranes are at least partially coated with a polymer prepared from the polymerization of at least one monomer and at least one cross-linker, and wherein the at least one monomer is chosen from various charged monomers. The membrane assemblies of the disclosure show improved metal ion removal efficiency, and the devices of the disclosure exhibit superior performance when placed into a solvent in idle mode insofar as only minute quantities, i.e., no greater than 0.080 ppb of various metal ions were surprisingly found to leach out from the porous polymeric membranes contained therein. This result can be compared to the data showing metal ion leaching from similar membranes having a UPE polymeric backbone as set forth in the Examples below. The coatings recited herein are prepared from one or more cross-linkers and one or more monomers comprised, consisting of, or consisting essentially of those monomers and cross-linkers as described herein.

### BRIEF DESCRIPTION OF THE DRAWINGS

FIG. 1 is a depiction of an exemplary filter device.

### DETAILED DESCRIPTION

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The term “about” generally refers to a range of numbers that is considered equivalent to the recited value (e.g., having the same function or result). In many instances, the term “about” may include numbers that are rounded to the nearest significant figure.

Numerical ranges expressed using endpoints include all numbers subsumed within that range (e.g., 1 to 5 includes 1, 1.5, 2, 2.75, 3, 3.80, 4 and 5).

In a first aspect the disclosure provides a membrane assembly comprising:
a. a porous membrane comprising poly(tetrafluoroethylene), wherein the membrane has a coating thereon, wherein the coating is prepared from the polymerization of at least one monomer and at least one cross-linker, wherein the monomer has a positive charge in an organic liquid; and
b. a porous membrane comprising poly(tetrafluoroethylene), wherein the membrane has a coating thereon, wherein the coating is prepared from the polymerization of at least one monomer and at least one cross-linker, wherein the monomer has a negative charge in an organic liquid; and
wherein the assembly exhibits a total removal efficiency of greater than 90% of one or more metal ions chosen from ions of lithium, boron, sodium, magnesium, aluminum, potassium, calcium, titanium, vanadium, chromium, manganese, iron, nickel, copper, zinc, molybdenum, silver, tin, barium, and lead, in a sample containing 1 ppb of metal ions chosen from ions of lithium, boron, sodium, magnesium, aluminum, potassium, calcium, titanium, vanadium, chromium, manganese, iron, nickel, copper, zinc, molybdenum, silver, tin, barium, and lead.

The membrane assemblies as referred to herein are in general a pleat pack of two or more membranes stacked on one another, through which the organic liquids would pass in operation. The membranes can be spaced with a support material such as a polymeric screen, if desired.

As referred to above, the porous poly(tetrafluoroethylene) (PTFE) membranes, as modified herein, were found to provide purified solvents. The underlying PTFE membranes are widely-available commercially. The PTFE membranes described herein can have a variety of geometric configurations, such as a flat sheet, a corrugated sheet, a pleated sheet, and a hollow fiber, among others. The porous membrane can have a pore structure that can be isotropic or anisotropic, skinned or unskinned, symmetric or asymmetric, any combination of these or can be a composite membrane including one or more retentive layers and one or more support layers. Furthermore, the coated porous membrane can be supported or unsupported by webs, nets, and cages, among others.

In order to prepare the membranes of the disclosure, the methodology of US Patent Publication No. 2020/0206691, incorporated herein by reference in its entirety, can be utilized.

In short, certain functional groups having a positive or negative charge can be introduced onto the surface of the polymeric membrane by coating the membrane with a coating having the desired pendant functional groups.

In general, the coating comprises an organic backbone formed from certain polymerized monomers. The coating can thus be prepared from various monomers having at least one carbon-carbon double bond, including monomers and cross-linkers, and prepared by initiating a free-radical polymerization reaction which then provides a coating onto the surface of the PTFE membrane. Cross-linkers are generally difunctional monomers. Polymerization and cross-linking of the polymerizable monomers onto the porous membrane substrate is effected so at least a portion and up to the entire surface of the porous membrane, including the inner pore surfaces of the porous membrane, is modified with a cross-linked polymer coating. It should thus be understood that the disclosure encompasses coating the porous membrane with as much of the surface of the membrane as desired, from greater than 0% to 100%, with the cross-linked polymer composition.

Exemplary monomers having a positive charge in an organic liquid that can be used in the coating in embodiments of the disclosure can include, but are not limited to, 2-(dimethylamino)ethyl hydrochloride acrylate, [2-(acryloyloxy)ethyl]trimethylammonium chloride, 2-aminoethyl methacrylate hydrochloride, N-(3-aminopropyl) methacrylate hydrochloride, 2-(dimethylamino)ethyl methacrylate hydrochloride, [3-(methacryloylamino)propyl]trimethylammonium chloride solution, [2-(methacryloyloxy)ethyl]trimethylammonium chloride, acrylamidopropyl trimethylammonium chloride, 2-aminoethyl methacrylamide hydrochloride, N-(2-aminoethyl) methacrylamide hydrochloride, N-(3-aminopropyl)-methacrylamide hydrochloride, diallyldimethylammonium chloride, vinyl benzyl trimethyl ammonium chloride, allylamine hydrochloride, vinyl imidazolium hydrochloride, vinyl pyridinium hydrochloride, and vinyl benzyl trimethyl ammonium chloride, either individually or in combinations of two or more thereof. It should be appreciated that some monomers with a positive charge listed above, comprise a quaternary ammonium group and are naturally charged in organic solvent while other monomers with a positive charge such as comprising primary, secondary and tertiary amines are adjusted to create charge by treatment with an acid. Monomers which can be positively charged in an organic solvent, either naturally or by treatment, can be polymerized and cross-linked with a cross-linker to form a coating on the porous membrane that is also positively charged when in contact with an organic solvent. In certain embodiments, the monomers having a positive charge in an organic liquid are chosen from diallyldimethylammonium chloride, diallyldimethylammonium bromide, acrylamido propyl trimethylammonium chloride (CAS No. 7398-69-8), acrylamido propyl trimethylammonium bromide, vinyl benzyl trimethylammonium chloride (CAS No. 26616-35-3), and vinyl benzyl trimethylammonium bromide. In certain embodiments, the coating is prepared from the polymerization of diallyldimethylammonium chloride an at least one cross-linker. It should be appreciated that some of these monomers comprise a quaternary ammonium group and are naturally charged in a polar solvent while other monomers with a positive charge such as comprising primary, secondary and tertiary amines can be adjusted to create charge by treatment with an acid. It should also be appreciated that this free-radical polymerized coating can be prepared using the chloride or hydrochloride salt forms of the monomers as recited above, or can be converted to a different halide or hydrohalide form, or converted to the hydroxide form prior to polymerization. As such, this listing of monomers is intended to include variations in the associated anion, i.e., a different halide or different halide. In certain embodiments, the coating is prepared from monomers which comprise, consist of, or consist essentially of the positively charged monomers recited herein (and used in conjunction with one or more cross-linkers).

In certain embodiments, the coating on the porous PTFE membrane is prepared from polymerized monomers having a positive charge. It should be appreciated that embodiments of the disclosure can include a plurality of polymerized monomers with a positive charge which differ from each other (co-polymer) or are the same (homo-polymer). In an embodiment, some of the pluralities of polymerized monomers with a positive charge are the same. In another particular embodiment, some of the plurality of polymerized monomers with a positive charge differ from each other. The plurality of polymerized monomers with a positive charge may have one or more characteristics which differ from each other or are similar. In certain embodiments of such coatings, one or more of the polymerized monomers are different from each other and form a co-polymer with positive charges that are cross-linked with a cross-linker to other polymerized monomers.

Exemplary monomers having a negative charge in an organic liquid that can be used in the coating can include, but are not limited to, 2-ethylacrylic acid, acrylic acid, 2-carboxyethyl acrylate, 3-sulfopropyl acrylate potassium salt, 2-propyl acrylic acid, 2-(trifluoromethyl)acrylic acid, methacrylic acid, 2-methyl-2-propene-1-sulfonic acid sodium salt, mono-2-(methacryloyloxy)ethyl maleate, 3-sulfopropyl methacrylate potassium salt, 2-acrylamido-2-methyl-1-propanesulfonic acid, 3-methacrylamido phenyl boronic acid, vinyl sulfonic acid, and vinyl phosphonic acid, either individually or combinations of two or more thereof In a particular embodiment, the monomer with negative charge includes sulfonic acid. It should be appreciated that some monomers with a negative charge listed above, comprise a strong acid group and are naturally charged in organic solvent while other monomers with a negative charge comprising weak acids are adjusted to create charge by treatment with base. Monomers which are negatively charged in an organic solvent, either naturally or by treatment can be polymerized and cross-linked with at least one cross-linker to form a coating on a porous membrane that is negatively charged in an organic solvent. In certain embodiments, the coating is prepared from a monomer chosen from 2-methyl-2-propene-1-sulfonic acid salt (such as the sodium salt), 2-acrylamido-2-methyl-1-propanesulfonic acid, vinyl sulfonic acid, and vinyl phosphonic acid, or a salt thereof, and at least one cross-linker.

In one embodiment, the coating is prepared from a plurality of polymerized monomers with negative charges. It should be appreciated that embodiments of the disclosure can include those with a plurality of monomers with negative charges which differ from each other or are the same. In an embodiment, the plurality of monomers with negative charges are the same. In another particular embodiment, the plurality of monomers with negative charges differ from each other. The plurality of monomers with negative charges may have one or more characteristics which differ from each other or are similar. In an embodiment of the coating, the one or more polymerized monomers with negative charges that are cross-linked to other one or more polymerized monomers with negative charges. In another embodiment, the coating can be prepared from a combination of polymerized monomers which are positively charged and negative charged that are cross-linked on the same membrane or respectively on separate membranes. In another embodiment, the porous membrane is coated with polymerized monomers having a positive charge that are cross-linked and another separate porous membrane includes polymerized monomers with negative charges that are cross-linked. In another embodiment, the coating with polymerized monomers having positive and negative charges are cross-linked and on the same porous polymeric membrane. In still other embodiments, the coating with polymerized monomers which are cross-linked includes monomers that are zwitterionic and have both positive and negative charges on the same monomer in an organic liquid.

A zwitterionic monomer has both a positive and negative charge in the same monomeric backbone. Non-limiting examples of zwitterionic monomers that can be polymerized and cross-linked on surfaces of a membrane include [3-(Methacryloylamino)propyl]dimethyl(3-sulfopropyl)ammonium hydroxide; [2-(Methacryloyloxy)ethyl]dimethyl-(3-sulfopropyl)ammonium hydroxide; 2-(Methacryloyloxy)ethyl 2-(Trimethylammonio)ethyl Phosphate; 1-(3-Sulfopropyl)-2-vinylpyridinium hydroxide; and combinations of these.

In a further embodiment, a portion of about 0 to about 10 weight percent of uncharged monomers can be utilized in the polymerization reaction (based on the total weight of the reaction solution). Such monomers are in general ethylenically-unsaturated monomers chosen from acrylic and methacrylic esters, and vinyl compounds.

The cross-linkers as referred to above are uncharged difunctional (i.e., having two carbon-carbon double bonds) vinyl, acrylic or methacrylic monomeric species, optionally having an amide functionality. Non-limiting examples of such cross-linkers include methylene bis(acrylamide), tetraethylene glycol diacrylate, tetraethylene glycol diamethacrylate, divinyl sulfone, divinyl benzene, 1,3,5-Triallyl-1,3,5-triazine-2,4,6(1H,3H,5H)-trione 98%, ethylene glycol divinyl ether, divinyl polyethylene glycols, and triallylamine.

By way of illustration, polymerization and cross-linking of the polymerizable monomer onto the porous membrane substrate can be effected so that a select portion or the entire surface of the porous membrane, including the inner surfaces of the porous membrane, is modified with a cross-linked polymer.

With regard to the free-radical polymerization reaction which forms the coating, a reagent bath comprised of: (1) at least one polymerizable monomer which is ethylenically unsaturated and has at least one charged moiety, (2) a polymerization initiator, if needed, and (3) a cross-linking agent in a polar solvent such as a water soluble solvent for these three constituents, is contacted with the porous polymeric membrane substrate under conditions to effect polymerization and cross-linking of the monomer and deposition of the resulting cross-linked polymer onto the porous polymeric membrane substrate. Even though the solvent is a polar solvent, the requisite degree of membrane surface modification may be and is obtained. When the monomer is di-functional or has higher functionality, an additional cross-linking agent is not needed but may be used. Representative suitable polar solvents include solvents having a dielectric constant above 25° C. at room temperature such as polyols including 2-methyl-2,4-pentanediol, 2,4 pentanedione, glycerine or 2,2′-thiodiethanol; amides such as formamide, dimethyl formamide, dimethyl acetamide; alcohols such as methanol, or the like; and nitro substituted aromatic compounds including nitrobenzene, 2-furaldehyde, acetonitrile, 1-methyl pyrrolidone or the like. The particular solvent is chosen to solubilize the cross-linking agent, the monomer and the initiator, if present.

Suitable initiators for the monomers and cross-linking agents described above can be used. For example, suitable photoinitiators include benzophenone, 4-(2-hyroxyethoxy)phenyl-(2-hydroxy-2-propyl) ketone, azoisopropane or 2,2-dimethoxy-2-phenylacetophenone or the like. Suitable thermal initiators include organic peroxides such as dibenzoyl peroxide, t-butylhydroperoxide, cumylperoxide or t-butyl perbenzoate or the like and azo compounds such as azobisisobutyronitrile (AIBN) or 4,4,′-azobis(4-cyanovaleric acid) or the like.

In certain embodiments, the polymerizable monomer is present in the reactant solution at a concentration between about 2% and about 20%, or between about 5% and about 10% based upon the weight of the total solution. The cross-linking agent is present in an amount of between about 2% and about 10% by weight, based upon the weight of the polymerizable monomer. Greater amounts of cross-linking agents can be used. The polymerization initiator is present in an amount of between about 1% and about 10% by weight, based upon the weight of the polymerizable monomer. As noted above, the cross-linking agent can be utilized without the monomer and thereby functions as the polymerizable monomer.

In certain embodiments, the H⁺ ion-exchange capacity of the negatively-charged membranes of the disclosure, as measured via titration of ionizable groups is about 1 to about 100, about 1 to about 40, or about 1 to about 10 meq H⁺/m² membrane. (meq=milli-equivalents). Similarly, the OW ion-exchange capacity of positively-negatively charged membranes, as measured via titration of ionizable groups is about 1 to about 100, about 1 to about 40, or about 1 to about 10 meq H⁺/m² membrane.

Polymerization and cross-linking can be effected by exposing the monomer reaction system to ultraviolet (UV) light, thermal sources or ionizing radiation. The polymerization and cross-linking is effected in an environment where oxygen does not inhibit polymerization or cross-linking. The process is conveniently performed by dipping the membrane substrate in the solution containing the monomer, cross-linking agent, and the initiator, sandwiching the membrane between two ultraviolet light transparent sheets, such as polyethylene, or in a blanket of an inert gas such as nitrogen and exposing to UV light. The process can be performed continuously and the desired cross-linked coating formed after UV exposure is initiated. By controlling the reactant concentrations and UV exposure, as set forth above, a coated membrane is produced.

Thus, in a further aspect, the disclosure provides a porous membrane comprising poly(tetrafluoroethylene), wherein the membrane has a coating thereon, wherein the coating is prepared from the polymerization of at least one monomer and at least one cross-linker, and wherein the monomer has a positive charge in an organic liquid. In one embodiment, the monomer is a quaternary ammonium compound having at least one carbon-carbon double bond. In another embodiment, the quaternary ammonium compound is chosen from a diallyldimethyl ammonium halide, such as diallyldimethyl ammonium chloride or diallyldimethyl ammonium bromide, or vinyl benzyl trimethyl ammonium chloride or vinyl benzyl trimethyl ammonium bromide. In a further embodiment, the at least one monomer further comprises a monomer having a negative charge in an organic liquid.

The membranes of the disclosure can be used individually or as a combination or assembly of two or more membranes as desired. As is shown below in the Examples, a membrane having a positive charge and another membrane having a negative charge, used together as a membrane assembly, exhibited superior performance in removal efficiency for a wide variety of metal ion contaminants in various organic liquids. Accordingly, in a further aspect, the disclosure provides a membrane assembly comprising:
a. a porous membrane comprising poly(tetrafluoroethylene), wherein the membrane has a coating thereon, wherein the coating is prepared from the polymerization of at least one monomer and at least one cross-linker, wherein the monomer has a positive charge in an organic liquid; and
b. a porous membrane comprising poly(tetrafluoroethylene), wherein the membrane has a coating thereon, wherein the coating is prepared from the polymerization of at least one monomer and at least one cross-linker, wherein the monomer has a negative charge in an organic liquid; and
wherein the membrane assembly exhibits a total removal efficiency of greater than 90% of one or more metal ions chosen from ions of lithium, boron, sodium, magnesium, aluminum, potassium, calcium, titanium, vanadium, chromium, manganese, iron, nickel, copper, zinc, molybdenum, silver, tin, barium, and lead, in a sample containing 1 ppb of metal ions chosen from ions of lithium, boron, sodium, magnesium, aluminum, potassium, calcium, titanium, vanadium, chromium, manganese, iron, nickel, copper, zinc, molybdenum, silver, tin, barium, and lead.

Also as shown below in the examples, a filter device containing a positive membrane and a negative membrane also exhibited greatly reduced leaching of certain metal ions, believed to be from the polymeric backbone of the membrane. Accordingly, in a further aspect, the disclosure provides a filter device comprising a plurality of membranes, comprising:

a. a porous membrane comprising poly(tetrafluoroethylene), wherein the membrane has a coating thereon, wherein the coating is prepared from the polymerization of at least one monomer and at least one cross-linker, wherein the monomer has a positive charge in an organic liquid; and
b. a porous membrane comprising poly(tetrafluoroethylene), wherein the membrane has a coating thereon, wherein the coating is prepared from the polymerization of at least one monomer and at least one cross-linker, wherein the monomer has a negative charge in an organic liquid; and
wherein the filter device, when soaked in a PGME/PGMEA solution (70:30, by volume), for 8 hours generates less than 0.080 ppb of metal ions chosen from ions of sodium, magnesium, aluminum, potassium, calcium, iron, and zinc.

It should also be appreciated that methods of the disclosure include removing metal contaminants from a range of organic liquids, which can be liquids, either individually or in combinations of two or more thereof. Non limiting examples of organic liquids include cyclohexanone, isopentyl ether, propylene glycol monomethyl ether acetate (PGMEA), Methyl isobutyl carbinol, N-butyl acetate, Methyl-2-hydroxyisobutyrate, and a mixed solution of propylene glycol monomethyl ether (PGME) and PGMEA (7:3 mixing ratio surface tension of 27.7 mN/m), and either individually or in combinations of two or more thereof. A particular embodiment includes organic liquids which are immiscible with water such as but not limited to cyclohexanone and PGMEA. In an embodiment, immiscible with water means soluble in water up to at 19.8 g per 100 ml water.

The membranes, membrane assemblies, and filter devices of the disclosure are thus useful in removing metal ion contaminants from organic liquids. An embodiment of the disclosure includes removing metal contaminants from a combination of a plurality of organic liquids which differ from each other. A particular embodiment includes solvents used for photoresist. Examples of solvents used in photoresist include liquids such as but not limited to methyl-amyl ketone, ethyl-3-ethoxypropionate, propylene glycol methyl ether (PGME) propylene glycol methyletheracetate (PGMEA), methanol, ethyl acetate, and ethyl lactate, either individually or in combinations of two or more thereof.

The methods of the disclosure are not limited by a sequence or frequency or order of various acts or steps unless specified and may be repeated as desired.

As mentioned above, the method is not limited by a sequence or order unless specified and may be repeated as desired. In another embodiment, the membrane with cross-linked monomers with negative charges is first membrane, and the membrane with the cross-linked monomers with positive charges is the second membrane. Furthermore, a combination of polymerized monomers with positive and negative charges can be coated on the porous polymeric membrane. In another embodiment, the coating with polymerized monomers having positive and negative charges are on the same membrane. In an embodiment, the first membrane in a two-layer membrane stack can include a coating with polymerized monomers having positive and negative charges on the same membrane. In another embodiment, the second membrane in a two-layer membrane stack can include a coating with polymerized monomers having positive and negative charge on the same membrane. Sequence or frequency or order may be altered unless specified. It should be appreciated that the first and second membranes may effectively remove metal contaminants which differ from each other or at differing efficiency.

Another embodiment includes a method of removing metal contaminants from an organic liquid by passing an organic liquid through a porous polymeric membrane assembly having a plurality of layers. The porous polymeric membrane assembly includes first layer (or membrane) and second layer (or membrane). The first layer includes a coating having one or more cross-linked polymerized monomers with a positive charge. The second layer includes a coating having one or more cross-linked polymerized monomers with a negative charge. The organic liquid has a lower concentration of the metal contaminants after passing thru the porous polymeric membrane. In a particular embodiment, the organic liquid includes liquids used for photoresist. A combination of polymerized monomers with positive and negative charges can be coated on the layers of the polymeric membrane. It should be appreciated that different layers of a membrane and in a device housing the membrane(s) may effectively remove metal contaminants which differ from each other or at differing efficiency.

In certain embodiments, metal contaminants removed include Li, Na, Mg, Al, K, Ca, Ti, V, Cr, Mn, Fe, Co, Ni, Cu, Zn, Sr, Mo, Ag, Cd, Sn, Ba, and Pb ions, either individually or in combinations of two or more thereof. In another embodiment, metal contaminants are removed such as Al, Ca, Cr, Cu, Fe, Pb, Mg, Mn, Ni, K, Na, Sn, Ti, and Zn, either individually or in combinations of two or more thereof. In a particular embodiment, metal contaminants are removed such as Fe, Ni, Cr, Cu, and Al, either individually or in combinations of two or more thereof. In an embodiment, metal contaminants are removed such as Fe, Ni, and Cr, either individually or in combinations of two or more thereof. In an embodiment, metal contaminant removal efficiency of metals, such as Al, Ca, Cr, Cu, Fe, Pb, Mg, Mn, Ni, K, Na, Sn, Ti, and Zn combined, from water immiscible organic liquid after passing the water immiscible organic liquid thru the porous membrane or porous membrane assembly is about 90%, about 92%, about 95% or about 97% for removing metal contaminants from organic liquid immiscible with water. In the examples provided infra, a device with 1000 cm² membrane area was challenged with 1200 ml of solution of respective liquid. In a particular embodiment, metal contaminant removal efficiency is greater than 90%, 92%, 95%, 97%, and approaching 100%, as detailed in Table 2 below. In other words, the metal contaminant concentration in the organic liquid feed stream for one or more of the metal species listed above is reduced after passing through one or more of the coated porous PTFE membranes by about 99%, 98%, 97%, 96, 95%, 94%, 93%, 92%, 91%, 90% or 85% of the initial feed concentration. In some embodiments the metal contaminant concentration in the organic liquid feed stream is 150 parts per billion (ppb_{v/v}) or less and the metal contaminant removal is measured by passing the organic liquid feed stream through a device including 1000 cm² of coated porous membrane as described herein at a flow rate of 60 milliliters per minute (ml/min) and measuring the treated effluent organic liquid. In all cases, the reference to metal contaminants herein includes both metallic (i.e., zero valence) as well as ionic metal contaminants.

In some embodiments, as shown in Example 6 below, filter device comprising one or more coated porous PTFE membranes, when soaked in a PGME/PGMEA solution (70:30, by volume), for 8 hours generates less than 0.080 ppb of at least one metal ion chosen from ions of sodium, magnesium, aluminum, potassium, calcium, iron, and zinc. In some embodiments, the filter device soaked for 8 hours as described above, generates less than 0.080 ppb of each of the metal ions chosen from ions of sodium, magnesium, aluminum, potassium, calcium, iron, and zinc.

In another aspect, the disclosure provides a filtration device, comprising one or more of the membranes of the disclosure. One example of a filter structure that includes a filter membrane in the form of a pleated cylinder can be prepared to include the following component parts, any of which may be included in a filter construction but may not be required: a rigid or semi-rigid core that supports a pleated cylindrical coated filter membrane at an interior opening of the pleated cylindrical coated filter membrane; a rigid or semi-rigid cage that supports or surrounds an exterior of the pleated cylindrical coated filter membrane at an exterior of the filter membrane; optional end pieces or “pucks” that are situated at each of the two opposed ends of the pleated cylindrical coated filter membrane; and a filter housing that includes an inlet and an outlet. The filter housing can be of any useful and desired size, shape, and materials, and can preferably be made of suitable polymeric material.

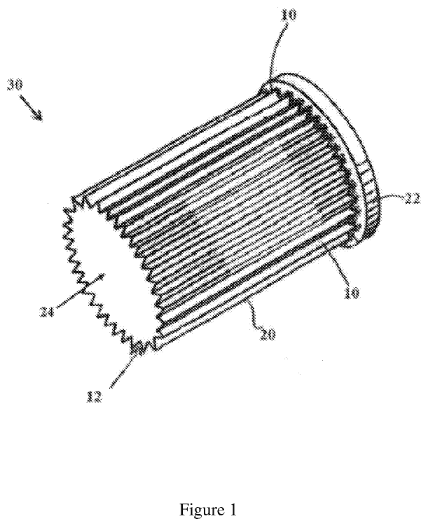

As one example, FIG. 1 shows filter component 30, which is a product of pleated cylindrical component 10 and end piece 22, with other optional components. Cylindrical component 10 includes a filter membrane 12, as described herein, and is pleated. In some embodiments, filter membrane 12 is a membrane assembly of multiple membranes, with optional separator material place between the individual membranes. End piece 22 is attached (e.g., “potted”) to one end of cylindrical filter component 10. End piece 22 can preferably be made of a melt-processable polymeric material. A core (not shown) can be placed at the interior opening 24 of pleated cylindrical component 10, and a cage (not shown) can be placed about the exterior of pleated cylindrical component 10. A second end piece (not shown) can be attached (“potted”) to the second end of pleated cylindrical component 30. The resultant pleated cylindrical component 30 with two opposed potted ends and optional core and cage can then be placed into a filter housing that includes an inlet and an outlet and that is configured so that an entire amount of a fluid entering the inlet must necessarily pass through the filtration membrane 12 before exiting the filter at the outlet.

### EXAMPLES

### Example 1

This example demonstrates how a porous polyethylene (UPE) membrane is surface modified with a coating having polymerized monomer with negative charges (Negative UPE Membrane).

A surface modification monomer solution was made which includes: 0.3% Irgacure 2959; 6% Methanol, 5.6% Acrylamido methyl Propane sulfonic acid (AMPS), 2.5% methylene bis acrylamide (MBAm) cross linker, and 85.6% water (The percentages in these Examples are weight percent, based on the total weight of the polymerization solution mixture).

A porous UPE membrane is surface modified with a coating having polymerized monomer with negative charges is prepared by the following method. First, a 47 mm disk of UPE porous membrane (84 um thick, 27 psi average mean bubble point in isopropanol (IPA), Entegris, Inc.) was wet with IPA solution for 25 sec. (By a bubble point test method, a sample of porous polymeric filter membrane is immersed in and wetted with a liquid having a known surface tension, and a gas pressure is applied to one side of the sample. The gas pressure is gradually increased. The minimum pressure at which the gas flows through the sample is called a bubble point. To determine the bubble point of a porous material a sample of the porous material is immersed in and wetted with isopropanol at a temperature of 20-25° C. (e.g., 22° C.). A gas pressure is applied to one side of the sample by using compressed air and the gas pressure is gradually increased.) Next, an exchange solution comprising 10% hexylene glycol and 90% water was used to rinse the membrane and remove IPA. The porous membrane disk was then introduced into the surface modification monomer solution and remained submerged for 2 minutes. The porous membrane disk was removed from the surface modification monomer solution and placed between transparent polyethylene sheets. Any excess solution was removed by rolling a rubber roller over the polyethylene/membrane disk/polyethylene sandwich as it lays flat on a table. The polyethylene sandwich was then taped to a transport unit which conveyed the assembly through a Fusion Systems broadband UV exposure lab unit emitting at wavelengths from 200 to 600 nm. Time of exposure was controlled by how fast the assembly moves through the UV unit. In this example, the assembly moved through the UV chamber at 10 feet per minute. After emerging from the UV unit, the membrane was removed from the sandwich and immediately placed in DI water, where it was allowed to soak for 5 minutes. Next, the treated membrane sample was transferred to methanol and allowed to soak for 5 minutes. Following this soaking procedure the membrane was dried on a holder in an oven operating at 50° C. for 10 min. Water flowtime of the membrane modified as described above was 400 sec/500 mL. The H+ ion-exchange capacity was measured via titration of ionizable groups and determined to be 4.2 meq H⁺/m² membrane. (meq=milli-equivalents). The resulting membrane was hydrophilic and spontaneously wet when submerged in deionized water.

### Example 2

This example demonstrates how a porous polyethylene (UPE) membrane is surface modified with a coating having polymerized monomer with positive charges (Positive UPE Membrane). A surface modification monomer solution was made which includes: 0.3% Irgacure 2959, 10% Methanol, 5.5% (3-Acrylamidopropyl)trimethylammonium chloride (APTAC), 2.0% N,N-Dimethylacrylamide (DMAM), 1.5% methylene bis acrylamide (MBAm) cross linker, and 80.7% water.

A porous PTFE membrane is surface modified with a coating having polymerized monomer with negative charges is prepared by the following method. First, a 47 mm disk of PTFE porous membrane (84 um thick, 27 psi average mean bubble point in IPA) was wet with IPA solution for 25 sec. Next, an exchange solution comprising 10% hexylene glycol and 90% water was used to rinse the membrane and remove IPA. The porous membrane disk was then introduced into the surface modification monomer solution and remained submerged for 2 minutes. The porous membrane disk was removed from the surface modification monomer solution and placed between transparent polyethylene sheets. Any excess solution was removed by rolling a rubber roller over the polyethylene/membrane disk/polyethylene sandwich as it lays flat on a table. The polyethylene sandwich was then taped to a transport unit which conveyed the assembly through a Fusion Systems broadband UV exposure lab unit emitting at wavelengths from 200 to 600 nm. Time of exposure was controlled by how fast the assembly moves through the UV unit. In this example, the assembly moved through the UV chamber at 10 feet per minute. After emerging from the UV unit, the membrane was removed from the sandwich and immediately placed in DI water, where it was allowed to soak for 5 minutes. Next, the treated membrane sample was transferred to methanol and allowed to soak for 5 minutes. Following this soaking procedure the membrane was dried on a holder in an oven operating at 50° C. for 10 min. Water flowtime of the membrane modified as described above was 780 sec/500 mL. The OH⁻ ion-exchange capacity was measured via titration of ionizable groups and determined to be 2.5 meq OH−/m² membrane. The resulting membrane was hydrophilic and spontaneously wet when submerged in deionized water.

### Example 3

This example demonstrates how a porous Polytetrafluoroethylene (PTFE) membrane is surface modified with a coating having polymerized monomer with negative charges (Negative PTFE Membrane).

A surface modification monomer solution was made which includes: 0.3% Irgacure 2959; 10% Methanol, 5.6% Acrylamido methyl Propane sulfonic acid (AMPS), 2.5% methylene bis acrylamide (MBAm) cross linker, and 81.6% water (by weight).

A porous PTFE membrane is surface modified with a coating having polymerized monomer with negative charges is prepared by the following method. First, a 47 mm disk of PTFE porous membrane (60 um thick, 25 psi average mean bubble point in IPA) was wet with IPA solution for 25 sec. Next, an exchange solution comprising 10% hexylene glycol and 90% water was used to rinse the membrane and remove IPA. The porous membrane disk was then introduced into the surface modification monomer solution and remained submerged for 2 minutes. The porous membrane disk was removed from the surface modification monomer solution and placed between transparent polyethylene sheets. Any excess solution was removed by rolling a rubber roller over the polyethylene/membrane disk/polyethylene sandwich as it lays flat on a table. The polyethylene sandwich was then taped to a transport unit which conveyed the assembly through a Fusion Systems broadband UV exposure lab unit emitting at wavelengths from 200 to 600 nm. Time of exposure was controlled by how fast the assembly moves through the UV unit. In this example, the assembly moved through the UV chamber at 10 feet per minute. After emerging from the UV unit, the membrane was removed from the sandwich and immediately placed in DI water, where it was allowed to soak for 5 minutes. Next, the treated membrane sample was transferred to methanol and allowed to soak for 5 minutes. Following this soaking procedure the membrane was dried on a holder in an oven operating at 50° C. for 10 min. Water flowtime of the membrane modified as described above was 250 sec/500 mL. The H+ ion-exchange capacity was measured via titration of ionizable groups and determined to be 3.2 meq H+/m² membrane. The resulting membrane was hydrophilic and spontaneously wet when submerged in deionized water.

### Example 4

This example demonstrates how a porous Polytetrafluoroethylene (PTFE) membrane is surface modified with a coating having polymerized monomer with positive charges (Positive PTFE Membrane).

A surface modification monomer solution was made which includes: 0.3% Irgacure 2959, 10% Methanol, 4% (3-Acrylamidopropyl)trimethylammonium chloride (APTAC), 4% diallyldimethylammonium chloride (DADMAC), 2.5% methylene bis acrylamide (MBAm) cross linker, and 79.2% water.

A porous PTFE membrane is surface modified with a coating having polymerized monomer with negative charges is prepared by the following method. First, a 47 mm disk of PTFE porous membrane (60 um thick, 24 psi average mean bubble point in IPA) was wet with IPA solution for 25 sec. Next, an exchange solution comprising 10% hexylene glycol and 90% water was used to rinse the membrane and remove IPA. The porous membrane disk was then introduced into the surface modification monomer solution and remained submerged for 2 minutes. The porous membrane disk was removed from the surface modification monomer solution and placed between transparent polyethylene sheets. Any excess solution was removed by rolling a rubber roller over the polyethylene/membrane disk/polyethylene sandwich as it lays flat on a table. The polyethylene sandwich was then taped to a transport unit which conveyed the assembly through a Fusion Systems broadband UV exposure lab unit emitting at wavelengths from 200 to 600 nm. Time of exposure was controlled by how fast the assembly moves through the UV unit. In this example, the assembly moved through the UV chamber at 10 feet per minute. After emerging from the UV unit, the membrane was removed from the sandwich and immediately placed in DI water, where it was allowed to soak for 5 minutes. Next, the treated membrane sample was transferred to methanol and allowed to soak for 5 minutes. Following this soaking procedure the membrane was dried on a holder in an oven operating at 50° C. for 10 min. Water flowtime of the membrane modified as described above was 370 sec/500 mL. The OH− ion-exchange capacity was measured via titration of ionizable groups and determined to be 3.2 meq OH−/m² membrane. The resulting membrane was hydrophilic and spontaneously wet when submerged in deionized water.

### Example 5: Metal Removal Efficiency in Different Photolithography Solvents

This example demonstrates the ability of porous polyethylene (UPE) membrane surface modified with a coating having polymerized monomer with negative charges, porous UPE membrane surface modified with a coating having polymerized monomer with positive charges, and a membrane assembly of porous Polytetrafluoroethylene (PTFE) membrane is surface modified with a coating having polymerized monomer with negative charges and porous Polytetrafluoroethylene (PTFE) membrane surface modified with a coating having polymerized monomer with positive charges to reduce metals in solvents commonly used in photolithography.

47 mm coupons of different purifiers, Negative UPE Membrane (made according to Example 1), Positive UPE Membrane (made according to Example 2), and assemblies of Positive PTFE Membrane (made according to Example 4)/Negative PTFE Membrane (made according to Example 3), were used to evaluate the metal removal performance in different polar and non-polar solvents such as propylene glycol methyl ether (PGME)/propylene glycol methyl ethyl acetate (PGMEA) (70/30), propylene glycol methyl ethyl acetate (PGMEA), cyclohexanone (CHN) and n-butyl acetate (n-BA). The purifier membrane assemblies were first pre-cleaned and then installed in a clean PFA (Perfluoro alkoxy) coupon holder. Each of the test solvents were spiked with a known concentration (1 ppb containing 21 metals) using Conostan® Oil Standard S-21 from SCP Science. The samples were collected from the downstream of the purifier membrane assemblies at a volume interval of 50 mL, 100 mL, and 150 mL. The feed and filtrate samples were analyzed using an Agilent ICPMS 8900 to evaluate the metal removal performance between the three purifiers. The results are presented in % removal in Tables 1a-1d for individual metals and Table 2 for total metals. From the data shown below, Positive PTFE Membrane/Negative PTFE Membrane exhibits similar or better performance than Negative and Positive UPE Membrane for all the metals in all the solvents tested. Table 2 summarizes the average total metal removal efficiency in the various commonly encountered solvents in photolithography. While Positive UPE Membrane can remove a subset of metals from a range of solvents and Negative UPE Membrane can also remove a subset of metals from a range of solvents, the Positive PTFE Membrane/Negative PTFE Membrane metal purifier membrane assembly can achieve removal efficiency greater than 90% over a wide range of solvent polarities.

Total Metal Concentration @ 150 ml Filtrate (1 ppb Each Metal Spike)

TABLE 1a
PGME/PGMEA (70/30; volume:volume)

| | | | Positive PTFE |
|---|---|---|---|
| | Negative UPE | Positive UPE | Membrane/Negative |
| ppb | Membrane | Membrane | PTFE Membrane |
| Li | 0.00 | 0.91 | 0.00 |
| Na | 0.00 | 0.94 | 0.00 |
| Mg | 0.22 | 0.53 | 0.15 |
| Al | 0.00 | 0.39 | 0.00 |
| K | 0.03 | 0.65 | 0.04 |
| Ca | 0.00 | 0.27 | 0.00 |
| Ti | 0.04 | 0.32 | 0.00 |
| V | 0.59 | 0.73 | 0.51 |
| Cr | 0.08 | 0.60 | 0.08 |
| Mn | 0.00 | 0.19 | 0.00 |
| Fe | 0.00 | 0.54 | 0.02 |
| Ni | 0.00 | 0.50 | 0.00 |
| Cu | 0.03 | 0.37 | 0.00 |
| Zn | 0.00 | 0.14 | 0.00 |
| Mo | 0.71 | 0.62 | 0.62 |
| Ag | 0.34 | 0.00 | 0.00 |
| Cd | 0.00 | 0.00 | 0.00 |
| Sn | 0.01 | 0.35 | 0.01 |
| Ba | 0.00 | 0.25 | 0.01 |
| Pb | 0.00 | 0.28 | 0.00 |
| Total | 2.04 | 8.59 | 1.42 |

TABLE 1b
PGMEA

| | | | Positive PTFE |
|---|---|---|---|
| | Negative UPE | Positive UPE | Membrane/Negative |
| ppb | Membrane | Membrane | PTFE Membrane |
| Li | 0.00 | 0.058 | 0.00 |
| Na | 0.02 | 0.294 | 0.01 |
| Mg | 0.15 | 0.064 | 0.01 |
| Al | 0.01 | 0.026 | 0.00 |
| K | 0.00 | 0.266 | 0.00 |
| Ca | 0.15 | 0.188 | 0.02 |
| Ti | 0.00 | 0.001 | 0.00 |
| V | 0.01 | 0.009 | 0.00 |
| Cr | 0.03 | 0.052 | 0.01 |
| Mn | 0.00 | 0.000 | 0.00 |
| Fe | 0.33 | 0.030 | 0.00 |
| Ni | 0.00 | 0.197 | 0.00 |
| Cu | 0.00 | 0.140 | 0.00 |
| Zn | 0.01 | 0.000 | 0.00 |
| Mo | 0.07 | 0.032 | 0.02 |
| Ag | 0.00 | 0.000 | 0.00 |
| Cd | 0.00 | 0.000 | 0.00 |
| Sn | 0.01 | 0.004 | 0.02 |
| Ba | 0.03 | 0.044 | 0.00 |
| Pb | 0.00 | 0.000 | 0.00 |
| Total | 0.81 | 1.41 | 0.08 |

TABLE 1c
n-butyl acetate

| | | | Positive PTFE |
|---|---|---|---|
| | Negative UPE | Positive UPE | Membrane/Negative |
| ppb | Membrane | Membrane | PTFE Membrane |
| Li | 0.0 | 0.0 | 0.0 |
| Na | 0.2 | 0.1 | 0.0 |
| Mg | 0.1 | 0.2 | 0.0 |
| Al | 0.0 | 0.1 | 0.0 |
| K | 0.2 | 0.1 | 0.0 |
| Ca | 0.2 | 0.2 | 0.0 |
| Ti | 0.0 | 0.1 | 0.0 |
| V | 0.0 | 0.1 | 0.0 |
| Cr | 0.0 | 0.2 | 0.0 |
| Mn | 0.0 | 0.0 | 0.0 |
| Fe | 0.2 | 0.1 | 0.0 |
| Ni | 0.0 | 0.1 | 0.0 |
| Cu | 0.0 | 0.4 | 0.0 |
| Zn | 0.1 | 0.3 | 0.0 |
| Mo | 0.0 | 0.1 | 0.0 |
| Ag | 0.0 | 0.0 | 0.0 |
| Cd | 0.0 | 0.0 | 0.0 |
| Sn | 0.0 | 0.1 | 0.0 |
| Ba | 0.0 | 0.2 | 0.0 |
| Pb | 0.0 | 0.2 | 0.0 |
| Total | 1.05 | 2.66 | 0.04 |

TABLE 1d
Cyclohexanone

| | | | Positive PTFE |
|---|---|---|---|
| | Negative UPE | Positive UPE | Membrane/Negative |
| ppb | Membrane | Membrane | PTFE Membrane |
| Li | 0.00 | 0.005 | 0.00 |
| Na | 0.00 | 0.589 | 0.00 |
| Mg | 0.00 | 0.001 | 0.00 |
| Al | 0.00 | 0.000 | 0.00 |
| K | 0.00 | 1.419 | 0.00 |
| Ca | 0.00 | 0.400 | 0.00 |
| Ti | 0.00 | 0.000 | 0.00 |
| V | 0.24 | 0.079 | 0.03 |
| Cr | 0.02 | 0.053 | 0.00 |
| Mn | 0.00 | 0.000 | 0.00 |
| Fe | 0.42 | 0.000 | 0.00 |
| Ni | 0.00 | 0.004 | 0.00 |
| Cu | 0.00 | 0.203 | 0.00 |
| Zn | 0.00 | 0.000 | 0.00 |
| Mo | 0.38 | 0.140 | 0.09 |
| Ag | 0.53 | 0.000 | 0.00 |
| Cd | 0.08 | 0.000 | 0.00 |
| Sn | 0.15 | 0.001 | 0.00 |
| Ba | 0.00 | 0.587 | 0.00 |
| Pb | 0.00 | 0.000 | 0.00 |
| Total | 1.82 | 3.48 | 0.12 |

TABLE 2
Metal Removal Efficiency Comparison between Negative
UPE Membrane, Positive UPE Membrane and
Positive PTFE Membrane/Negative PTFE Membrane
Total Metal Removal Efficiency @ 150 ml filtrate
(coupon level), %

| | | | Positive PTFE |
|---|---|---|---|
| | | | Membrane/ |
| | Negative UPE | Positive UPE | Negative PTFE |
| Solvent | Membrane | Membrane | Membrane |
| PGME/ | 89.9 | 57.4 | 92.9 |
| PGMEA | | | |
| (70/30) | | | |
| PGMEA | 77.7 | 92.2 | 99.5 |
| CHN | 80.2 | 85.9 | 97.2 |
| n-BA | 94.0 | 85.6 | 100 |

As shown in the Tables above, the combination of a positive PTFE membrane and a negative PTFE membrane had unexpectedly better metal removal efficiency and total metal removal efficiency than the UPE membranes.

### Example 6: Idle Soak Study

Negative UPE Membrane (made according to Example 1) and a new assembly of Positive PTFE Membrane (made according to Example 4)/Negative PTFE Membrane (made according to Example 3) placed in an Optimizer® D capsule (Entegris, Inc.) format were soaked in PGME/PGMEA (70/30) and left idle for certain periods (1 hour, 8 hours, and 24 hours) to investigate the metal leaching from the purifier in idle condition. Both the purifiers were filled with the solvent and left soaking for an initial time of 1 hour. After 1 hour a sample was taken for ICPMS analysis. Both the lines and the optimizer D were then emptied out and filled with fresh blend of PGME/PGMEA (70/30) and left to soak for 8 hours and finally 24 hours. The samples were tested using an Agilent ICPMS 8900. Table 3 below demonstrates the metal leaching behavior between Negative UPE Membrane and Positive PTFE Membrane/Negative PTFE Membrane over time under idle soak conditions in PGME/PGMEA (70/30) in removing metal ions of Na, Mg, Al, K, Ca, Fe, and Zn. Negative UPE Membrane shows significant metal level at hour in comparison to Positive PTFE Membrane/Negative PTFE Membrane with common metals like Fe, Zn and Ca. For Negative UPE Membrane, the metal seems to be leaching even after a 24-hour soak whereas for Positive PTFE Membrane/Negative PTFE Membrane, the metal leaching behavior is not seen over time, with same level of metal from 1 hour to 8 hours to 24 hours.

TABLE 3

| | | | | Positive PTFE membrane/ | | |
|---|---|---|---|---|---|---|
| | Negative UPE membrane | | | Negative PTFE membrane | | |
| | 1-hour | 8-hour | 24-hour | 1-hour | 8-hour | 24-hour |
| ppb | soak | soak | soak | soak | soak | soak |
| Na | 0.077 | 0.073 | 0.262 | 0.057 | 0.061 | 0.114 |
| Mg | 0.072 | 0.225 | 0.311 | 0.027 | 0.062 | 0.065 |
| Al | 0.107 | 0.000 | 0.000 | 0.000 | 0.000 | 0.000 |
| K | 0.046 | 0.051 | 0.047 | 0.044 | 0.079 | 0.038 |
| Ca | 0.285 | 0.021 | 0.028 | 0.071 | 0.059 | 0.023 |
| Fe | 1.053 | 0.430 | 0.181 | 0.061 | 0.073 | 0.035 |
| Zn | 1.441 | 0.949 | 0.555 | 0.057 | 0.075 | 0.078 |

As shown in Table 3, above the combination of a positive PTFE membrane and a negative PTFE membrane had unexpectedly better overall leaching behavior than the UPE membrane.

Aspects

In a first aspect, the disclosure provides a membrane assembly comprising:
a. a porous membrane comprising poly(tetrafluoroethylene), wherein the membrane has a coating thereon, wherein the coating is prepared from the polymerization of at least one monomer and at least one cross-linker, wherein the monomer has a positive charge in an organic liquid; and
b. a porous membrane comprising poly(tetrafluoroethylene), wherein the membrane has a coating thereon, wherein the coating is prepared from the polymerization of at least one monomer and at least one cross-linker, wherein the monomer has a negative charge in an organic liquid; and
wherein the assembly exhibits a total removal efficiency of greater than 90% of one or more metal ions chosen from ions of lithium, boron, sodium, magnesium, aluminum, potassium, calcium, titanium, vanadium, chromium, manganese, iron, nickel, copper, zinc, molybdenum, silver, tin, barium, and lead, from a feed stream containing 1 ppb of metal ions chosen from ions of lithium, boron, sodium, magnesium, aluminum, potassium, calcium, titanium, vanadium, chromium, manganese, iron, nickel, copper, zinc, molybdenum, silver, tin, barium, and lead.

In a second aspect, the disclosure provides the assembly of the first aspect, wherein the assembly exhibits a total removal efficiency of greater than 90% for all of the metal ions chosen from ions of lithium, boron, sodium, magnesium, aluminum, potassium, calcium, titanium, vanadium, chromium, manganese, iron, nickel, copper, zinc, molybdenum, silver, tin, barium, and lead.

In a third aspect, the disclosure provides the assembly of the first or second aspect, wherein the metal ions are chosen from iron, nickel, chromium, copper, and aluminum Al ions.

In a fourth aspect, the disclosure provides the assembly of the first or second aspect, wherein the metal ions are chosen from manganese, magnesium, and zinc ions.

In a fifth aspect, the disclosure provides the assembly of the first, second, or third aspect, wherein the metal ions are chosen from iron, nickel, and chromium ions.

In a sixth aspect, the disclosure provides the assembly of the first, second, or fourth aspect, wherein the metal ion is a manganese ion.

In a seventh aspect, the disclosure provides the assembly of the first, second, or fourth aspect, wherein the metal ion is a magnesium ion.

In an eighth aspect, the disclosure provides the assembly of the first, second, or third aspect, wherein the metal ion is a zinc ion.

In a ninth aspect, the disclosure provides the assembly of any preceding aspect, wherein the monomer having a positive charge in an organic liquid is a quaternary ammonium compound having at least one carbon-carbon double bond.

In a tenth aspect, the disclosure provides the assembly of the ninth aspect wherein the quaternary ammonium compound is chosen from diallyldimethyl ammonium chloride, diallyldimethyl ammonium bromide, vinyl benzyl trimethyl ammonium chloride, and vinyl benzyl trimethyl ammonium bromide.

In an eleventh aspect, the disclosure provides the assembly of any preceding aspect, wherein the cross-linker is chosen from methylene bis(acrylamide), tetraethylene glycol diacrylate, tetraethylene glycol diamethacrylate, divinyl sulfone, divinyl benzene, 1,3,5-Triallyl-1,3,5-triazine-2,4,6(1H,3H,5H)-trione 98%, ethylene glycol divinyl ether, divinyl polyethylene glycols, and triallylamine.

In a twelfth aspect, the disclosure provides the assembly of any preceding aspect, wherein the feed stream comprises a PGME/PGMEA solution (70:30, by volume), PGMEA, n-butyl acetate, or cyclohexanone.

In a thirteenth aspect, the disclosure provides a filter device comprising the assembly of any preceding aspect.

In a fourteenth aspect the disclosure provides a filter device comprising a plurality of membranes, comprising:
a. a porous membrane comprising poly(tetrafluoroethylene), wherein the membrane has a coating thereon, wherein the coating is prepared from the polymerization of at least one monomer and at least one cross-linker, wherein the monomer has a positive charge in an organic liquid; and
b. a porous membrane comprising poly(tetrafluoroethylene), wherein the membrane has a coating thereon, wherein the coating is prepared from the polymerization of at least one monomer and at least one cross-linker, wherein the monomer has a negative charge in an organic liquid; and
wherein the filter device, when soaked in a PGME/PGMEA solution (70:30, by volume), for 8 hours generates less than 0.080 ppb of at least one metal ion from ions of sodium, magnesium, aluminum, potassium, calcium, iron, and zinc.

In a fifteenth aspect, the disclosure provides the filter device of the fourteenth aspect, wherein the monomer having a positive charge is a quaternary ammonium compound having at least one carbon-carbon double bond.

In a sixteenth aspect, the disclosure provides the filter device of the fifteenth aspect, wherein the quaternary ammonium compound is chosen from diallyldimethyl ammonium chloride, diallyldimethyl ammonium bromide, vinyl benzyl trimethyl ammonium chloride, and vinyl benzyl trimethyl ammonium bromide.

In a seventeenth aspect, the disclosure provides the filter device of any of the fourteenth through sixteenth aspects, wherein the cross-linker is chosen from methylene bis(acrylamide), tetraethylene glycol diacrylate, tetraethylene glycol diamethacrylate, divinyl sulfone, divinyl benzene, 1,3,5-Triallyl-1,3,5-triazine-2,4,6(1H,3H,5H)-trione 98%, ethylene glycol divinyl ether, divinyl polyethylene glycols, and triallylamine.

In an eighteenth aspect, the disclosure provides the filter device of any of the fourteenth through seventeenth aspects, wherein the device generates less than 0.080 ppb of metal ions of each of ions of sodium, magnesium, aluminum, potassium, calcium, iron, and zinc.

In a nineteenth aspect, the disclosure provides a porous membrane comprising poly(tetrafluoroethylene), wherein the membrane has a coating thereon, wherein the coating is prepared from the polymerization of at least one monomer and at least one cross-linker, and wherein the monomer has a positive charge in an organic liquid; and wherein the monomer is a quaternary ammonium compound having at least one carbon-carbon double bond.

In a twentieth aspect, the disclosure provides the membrane of the nineteenth aspect, wherein the quaternary ammonium compound is chosen from diallyldimethyl ammonium chloride, diallyldimethyl ammonium bromide, vinyl benzyl trimethyl ammonium chloride, and vinyl benzyl trimethyl ammonium chloride, and vinyl benzyl trimethyl ammonium bromide.

In a twenty-first aspect, the disclosure provides the membrane of the nineteenth or twentieth aspect, wherein the at least one monomer further comprises a monomer having a negative charge in an organic liquid.

In a twenty-second aspect, the disclosure provides the membrane of any of the nineteenth through twenty-first aspects, wherein the monomer having a negative charge in an organic liquid is chosen from 2-ethylacrylic acid, acrylic acid, 2-carboxyethyl acrylate, 3-sulfopropyl acrylate potassium salt, 2-propyl acrylic acid, 2-(trifluoromethyl)acrylic acid, methacrylic acid, 2-methyl-2-propene-1-sulfonic acid sodium salt, mono-2-(methacryloyloxy)ethyl maleate, 3-sulfopropyl methacrylate potassium salt, 2-acrylamido-2-methyl-1-propanesulfonic acid, 3-methacrylamido phenyl boronic acid, vinyl sulfonic acid, acrylamidomethyl propane sulfonic acid, and vinyl phosphonic acid.

In a twenty-third aspect, the disclosure provides the membrane of the twenty-second aspect, wherein the monomer having a negative charge in an organic liquid is acrylamidomethyl propane sulfonic acid.

In a twenty-fourth aspect, the disclosure provides a filter device comprising the membrane of any of the nineteenth through the twenty-third aspects.

In a twenty-fifth aspect, the disclosure provides a method of removing metal contaminants from an organic liquid, the method comprising: passing a liquid through (i) the membrane assembly of any one of the first through the twelfth aspects; (ii) the filter device of any one of the thirteenth through the eighteenth aspects; or (iii) the membrane of any one of the nineteenth through the twenty-third aspects.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respects, only illustrative. The disclosure's scope is, of course, defined in the language in which the appended claims are expressed.

What is claimed is:

1. A membrane assembly comprising:
a. a porous membrane comprising poly(tetrafluoroethylene), wherein the membrane has a coating thereon, wherein the coating is prepared from the polymerization of at least one monomer and at least one cross-linker, wherein the monomer has a positive charge in an organic liquid; and
b. a porous membrane comprising poly(tetrafluoroethylene), wherein the membrane has a coating thereon, wherein the coating is prepared from the polymerization of at least one monomer and at least one cross-linker, wherein the monomer has a negative charge in an organic liquid; and
wherein the assembly exhibits a total removal efficiency of greater than 90% of one or more metal ions chosen from ions of lithium, boron, sodium, magnesium, aluminum, potassium, calcium, titanium, vanadium, chromium, manganese, iron, nickel, copper, zinc, molybdenum, silver, tin, barium, and lead, from a feed stream containing 1 ppb of metal ions chosen from ions of lithium, boron, sodium, magnesium, aluminum, potassium, calcium, titanium, vanadium, chromium, manganese, iron, nickel, copper, zinc, molybdenum, silver, tin, barium, and lead.

2. The assembly of claim 1, wherein the assembly exhibits a total removal efficiency of greater than 90% for all of the metal ions chosen from ions of lithium, boron, sodium, magnesium, aluminum, potassium, calcium, titanium, vanadium, chromium, manganese, iron, nickel, copper, zinc, molybdenum, silver, tin, barium, and lead.

3. The assembly of claim 1, wherein the metal ions are chosen from iron, nickel, chromium, copper, and aluminum Al ions.

4. The assembly of claim 1, wherein the metal ions are chosen from manganese, magnesium, and zinc ions.

5. The assembly of claim 1, wherein the metal ions are chosen from iron, nickel, and chromium ions.

6. The assembly of claim 1, wherein the monomer having a positive charge in an organic liquid is a quaternary ammonium compound having at least one carbon-carbon double bond.

7. The assembly of claim 6, wherein the quaternary ammonium compound is chosen from diallyldimethyl ammonium chloride, diallyldimethyl ammonium bromide, vinyl benzyl trimethyl ammonium chloride, and vinyl benzyl trimethyl ammonium bromide.

8. The assembly of claim 1, wherein the cross-linker is chosen from methylene bis(acrylamide), tetraethylene glycol diacrylate, tetraethylene glycol diamethacrylate, divinyl sulfone, divinyl benzene, 1,3,5-Triallyl-1,3,5-triazine-2,4,6(1H,3H,5H)-trione 98%, ethylene glycol divinyl ether, divinyl polyethylene glycols, and triallylamine.

9. The assembly of any preceding claim, wherein the feed stream comprises a PGME/PGMEA solution (70:30, by volume), PGMEA, n-butyl acetate, or cyclohexanone.

10. A filter device comprising a plurality of membranes, comprising:
a. a porous membrane comprising poly(tetrafluoroethylene), wherein the membrane has a coating thereon, wherein the coating is prepared from the polymerization of at least one monomer and at least one cross-linker, wherein the monomer has a positive charge in an organic liquid; and
b. a porous membrane comprising poly(tetrafluoroethylene), wherein the membrane has a coating thereon, wherein the coating is prepared from the polymerization of at least one monomer and at least one cross-linker, wherein the monomer has a negative charge in an organic liquid; and
wherein the filter device, when soaked in a PGME/PGMEA solution (70:30, by volume), for 8 hours generates less than 0.080 ppb of at least one metal ion chosen from ions of sodium, magnesium, aluminum, potassium, calcium, iron, and zinc.

11. The filter device of claim 11, wherein the monomer having a positive charge is a quaternary ammonium compound having at least one carbon-carbon double bond.

12. The filter device of claim 12, wherein the quaternary ammonium compound is chosen from diallyldimethyl ammonium chloride, diallyldimethyl ammonium bromide, vinyl benzyl trimethyl ammonium chloride, and vinyl benzyl trimethyl ammonium bromide.

13. The filter device of claim 11, wherein the cross-linker is chosen from methylene bis(acrylamide), tetraethylene glycol diacrylate, tetraethylene glycol diamethacrylate, divinyl sulfone, divinyl benzene, 1,3,5-Triallyl-1,3,5-triazine-2,4,6(1H,3H,5H)-trione 98%, ethylene glycol divinyl ether, divinyl polyethylene glycols, and triallylamine.

14. The filter device of claim 11, wherein the device generates less than 0.080 ppb of metal ions from each of the ions of sodium, magnesium, aluminum, potassium, calcium, iron, and zinc.

15. A porous membrane comprising poly(tetrafluoroethylene), wherein:
the membrane has a coating thereon,
the coating is prepared from the polymerization of at least one monomer and at least one cross-linker,
the monomer has a positive charge in an organic liquid, and
the monomer is a quaternary ammonium compound having at least one carbon-carbon double bond.

16. The membrane of claim 16, wherein the quaternary ammonium compound is chosen from diallyldimethyl ammonium chloride, diallyldimethyl ammonium bromide, vinyl benzyl trimethyl ammonium chloride, and vinyl benzyl trimethyl ammonium chloride, and vinyl benzyl trimethyl ammonium bromide.

17. The membrane of claim 17, wherein the at least one monomer further comprises a monomer having a negative charge in an organic liquid.

18. The membrane of claim 16, wherein the monomer having a negative charge in an organic liquid is chosen from 2-ethylacrylic acid, acrylic acid, 2-carboxyethyl acrylate, 3-sulfopropyl acrylate potassium salt, 2-propyl acrylic acid, 2-(trifluoromethyl)acrylic acid, methacrylic acid, 2-methyl-2-propene-1-sulfonic acid sodium salt, mono (methacryloyloxy)ethyl maleate, 3-sulfopropyl methacrylate potassium salt, 2-acrylamido-2-methyl-1-propanesulfonic acid, 3-methacrylamido phenyl boronic acid, vinyl sulfonic acid, acrylamidomethyl propane sulfonic acid, and vinyl phosphonic acid.

19. The membrane of claim 19, wherein the monomer having a negative charge in an organic liquid is acrylamidomethyl propane sulfonic acid.

20. A method of removing metal contaminants from an organic liquid, the method comprising: passing a liquid through the membrane assembly of claim 1.
